(19) United States
(12) Patent Application Publication
(10) Pub. No.: US 2018/0062391 A1
(43) Pub. Date: Mar. 1, 2018

(54) Method For Optimizing Efficiency Of Optical Semiconductor Devices

(71) Applicant: Istvan Abonyi, College Point, NY (US)

(72) Inventor: Istvan Abonyi, College Point, NY (US)

(21) Appl. No.: 15/248,440

(22) Filed: Aug. 26, 2016

(51) Int. Cl. H02J 3/38; H05B 33/08; H02S 50/10

(52) U.S. Cl. CPC H02J 3/385; H05B 33/0815; H02S 50/10; H05B 33/089

(57) ABSTRACT

A method to subsequently increase efficiency of optical semiconductor devices is provided. The method comprises interrupting voltage of a light-emitting optical semiconductor device with a short duty cycle, the interrupting cycle in a range of 1%-5%. The method also comprises observing cool down of the optical semiconductor device to a greater extent than without the interruption and observing a resulting lower ambient temperature of the optical semiconductor device. The optical semiconductor devices convert light into electrical energy and experience, based on the interruption, greater increases in efficiency and lifetime than without the interruption. The optical semiconductor devices comprise at least one of comprising light-emitting optical semiconductor devices and light-absorbing optical semiconductor devices.

### CROSS REFERENCE TO RELATED APPLICATIONS

None

### FIELD OF INVENTION

The invention claimed herein is in the field of optical semiconductor device efficiency. More particularly, the present disclosure provides systems and method for light-emitting optical semiconductor devices to operate with more appreciable subsequent efficiency gains and longer lifetime than under previous implementations.

### BACKGROUND OF THE INVENTION AND DISCUSSION OF PRIOR ART

Optical semiconductor devices used in electronics have parameters that significantly depend on the temperature of operation. Consequently, the parameters of the optical semiconductor devices may significantly change at a specific temperature value. The parameters of optical semiconductor devices significantly deteriorate with the increase of temperature. Therefore an objective of the present invention is to assure that power amplifier units process energy converted by optical semiconductor devices with greater efficiency.

Following is a discussion of several items in the prior art in the same or similar technical area of the present disclosure. The items discussed below are not intended to be a complete or fully representative list of prior art.

U.S. Pat. No. 8,093,873 entitled METHOD FOR MAXIMUM POWER POINT TRACKING OF PHOTOVOLTAIC CELLS BY POWER CONVERTERS AND POWER COMBINERS provides a buffer condenser. The condenser may be noteworthy primarily for voltage increases, as it is connected to a coil and a switch element in an inverter mode. In the present disclosure, the switch element (Q) connects the solar cell (SC) directly to the buffer condenser (C). In U.S. Pat. No. 8,093,873, the solar cell directly connects to the buffer capacity, and the circuit is not interrupted. The energy efficiency promoted by the present disclosure is achieved by connecting the buffer condenser to the solar cell not continuously, but with 1%-3% interruptions.

Chinese patent CN 2882082 Y entitled SOLAR MODULE USING HIGH POWER SUPERHIGH CAPACITOR is similar to the present disclosure in using a buffer condenser. The subject Chinese patent applies a significantly larger capacity than does the method of the present disclosure. The larger capacity provided by the Chinese patent is provided as a superhigh capacity intended not to increase capacity (since the leakage current of the superhigh capacity is significantly higher than that of a battery) but to equalize the changes of the input energy, similarly to a battery. The circuit of the Chinese patent is not able to increase the original efficiency of the solar cell either, it is only able to equalize the input energy by storing it (however, by using the superhigh capacity it inserts additional losses into the existing system). The Chinese patent may be intended to assure that the capacity does not suddenly reduce in a cloudy weather or lower capacity periods, and that the energy stored in super capacities compensates the energy change during that time, similarly to a battery.

U.S. Pat. No. 8,106,597 entitled HIGH EFFICIENCY BOOST LED DRIVER WITH OUTPUT is similar to the present disclosure in using a buffer condenser the design of which within the circuit is completely different. In addition, the buffer condenser connects to the circuit via an inductivity connected in series. Further, in U.S. Pat. No. 8,106,597, the buffer condenser operates in an inverter. As any other inverters, it converts the input energy with losses. In U.S. Pat. No. 8,106,597, the several diodes connected in series result in losses in the inverter design, since there is a drop of 0.06V on the diodes, and the voltage drop on the three diodes significantly reduce the efficiency as the voltage drop on the diodes is converted into heat.

U.S. Pat. No. 8,193,741 entitled BOOSTING DRIVER CIRCUIT FOR LIGHT-EMITTING DIODES specifies as if were an LED booster. This patent however only measures and controls the voltage on the light-emitting optical semiconductor devices, in this case on the LEDs, and therefore it is intended to keep the current value specified by the LED chips at the set value. The circuit itself does not boost or increase the efficiency of the LED chips in question. This circuit is one of the common inverter solutions, and it equalizes the potential pulse induced by the inductivity by means of an inductivity connected in series and a switch element, and then stabilizes it via a buffer condenser.

U.S. Pat. No. 8,193,741 includes a buffer capacity, and the title of the patent contains the term “boost”. In fact, it is not a real boost, as it only connects the circuit to the LED applied as an optical semiconductor device. As in the above cases, this solution does not boost or increase the efficiency of the LED used as an optical semiconductor device. It only allows the LED to use the characteristic changes caused by the temperature fluctuation in a more optimal way.

In accordance with the state of the art, the characteristics indicated on FIG. 7 attached as an annex show how the brightness of LEDs used as high capacity optical semiconductor devices changes depending on the temperature. This indicates that even a change by a few C degrees dramatically affects the efficiency of the optical semiconductor device.

In accordance with the state of the art, FIG. 8 and FIG. 9 attached as annexes exhibit correlations with the temperatures of solar cells used as optical semiconductor devices. FIG. 8 and FIG. 9 indicate that the higher the temperature the lower the efficiency. This confirms that any temperature reduction results in efficiency increase. This temperature reduction can be achieved by using a duty cycle from 1% to 5% to subsequently increase the efficiency.

### SUMMARY

In an embodiment, a method to subsequently increase efficiency of optical semiconductor devices is provided. The method comprises interrupting voltage of a light-emitting optical semiconductor device with a short duty cycle, the interrupting cycle in a range of 1%-5%. The method also comprises observing cool down of the optical semiconductor device to a greater extent than without the interruption and observing a resulting lower ambient temperature of the optical semiconductor device. The optical semiconductor devices convert light into electrical energy and experience, based on the interruption, greater increases in efficiency and lifetime than without the interruption. The optical semiconductor devices comprise at least one of comprising light-emitting optical semiconductor devices and light-absorbing optical semiconductor devices.

### BRIEF DESCRIPTION OF THE DRAWINGS

FIG. 1 is a block diagram of a system of optimizing efficiency of optical semiconductor devices in accordance with an embodiment of the present disclosure.

FIG. 2 is a schematic diagram of a system of optimizing efficiency of optical semiconductor devices in accordance with an embodiment of the present disclosure.

FIG. 3 is a graph of a pulse series in accordance with an embodiment of the present disclosure.

FIG. 4 is a graph a pulse series in accordance with an embodiment of the present disclosure.

FIG. 5 is a block diagram of a system of optimizing efficiency of optical semiconductor devices in accordance with an embodiment of the present disclosure.

FIG. 6 is a schematic diagram of a system of optimizing efficiency of optical semiconductor devices in accordance with an embodiment of the present disclosure.

FIG. 7 is a graph of a pulse series in accordance with an embodiment of the present disclosure.

FIG. 8 is a graph indicating characteristics of how the brightness of high capacity light-emitting (LED) optical semiconductor devices change in accordance with an embodiment of the present disclosure.

FIG. 9 is a diagram of a solar panel and a solar cell in accordance with the existing state of the art.

FIG. 10 is a graph illustrating correlations between efficiency and temperature of solar cells implemented with optical semiconductor devices in accordance with the existing state of the art.

### DETAILED DESCRIPTION

The present disclosure provides application or connection methods that contribute to subsequent optimizations or reductions of parameter losses in optical semiconductor devices. Such subsequent optimizations or loss reductions are achieved by reducing temperatures generated by optical semiconductor devices, while increasing electric power transmitted by optical semiconductor devices rather than reducing such electric power. Heat losses of the optical semiconductor device may consequently be reduced. Connected or excited optical semiconductor devices are hence able to operate with higher efficiency.

Applications of methods provided herein may take place in solar cells created with optical semiconductor devices and in high capacity light-emitting optical semiconductor devices, i.e. LEDs. With solar cells, methods provided herein may be used for energy optimization and subsequent efficiency increase in energy conversion. In the case of high capacity light-emitting optical semiconductor devices, the subsequent capacity optimization of the optical semiconductor devices is performed as loading.

An objective of the present invention is to increase efficiency of light-emitting optical semiconductor devices. A further objective is to subsequently increase the efficiency of optical semiconductor devices generating electricity from light energy, such as solar panels, on the basis of the teachings here, of the same principle.

A basis for the present disclosure is a realization of the highly similar physical properties of the two types of optical semiconductor devices: 1) solar cells and 2) high capacity light-emitting optical semiconductor devices, i.e. LEDs. The realization is based on a physical property valid for substantially all optical semiconductor devices, which has not previously been widely applied in this field. Optical semiconductor components operating on this principle change their parameters depending on the temperature. Both the high capacity light-emitting optical semiconductor devices, or the LEDs in specific cases, and the high capacity light energy converting optical semiconductor devices, or solar cells in specific cases, follow the same principle. Therefore if their ambient temperature becomes higher, their efficiency is reduced.

The present disclosure teaches that if the light-emitting optical semiconductor devices are interrupted with short duty cycles from 1% to 5% at a specific frequency, then they are able to cool down to a greater extent. Thereby, their ambient temperature will be lower. As a result of the temperature reduction, the characteristic efficiency valid for all optical semiconductor devices will increase.

Efficiency increases may be subsequently achieved in light-emitting optical semiconductor devices or in LEDs in some cases. Such efficiency increases are confirmed with specific measurements. This effect results in similar significant efficiency increase in optical semiconductor devices converting light energy into electricity, i.e. in solar cells.

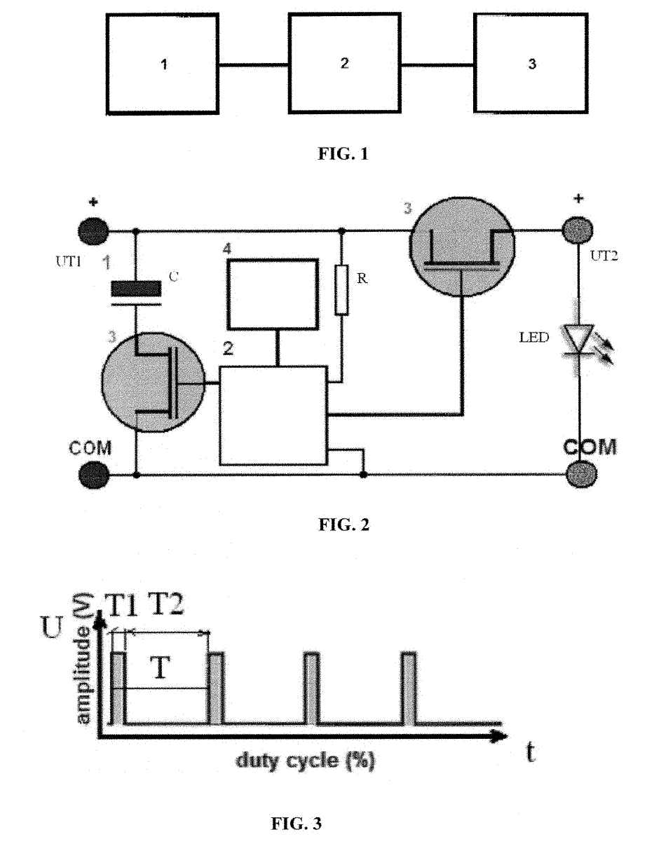

Turning to the figures, FIG. 1 is a block diagram of a system for optimizing efficiency of optical semiconductor devices. FIG. 1 depicts a layout of a circuit block implementing methods in a case of high capacity LED drives. FIG. 1 shows the layout of the circuit block implementing the procedure in the first case, i.e. in high capacity LED drives. On FIG. 1, box 1 contains an LED driver, box 2 contains an optimizing circuit, while box 3 contains an LED chip.

FIG. 2 is diagram of a system for optimizing efficiency of optical semiconductor devices. FIG. 2 depicts a potential circuit diagram for blocks indicated in FIG. 1. FIG. 2 shows a potential circuit diagram for the blocks indicated on FIG. 1. FIG. 2 shows that component 1, the buffer component in this case, is an energy storage condenser C. Component 2 is a control circuit with a processor. Component 4 is a sensor measuring both voltage and temperature. Components 3 are switch elements, which may be, in fact, any type of switch element having the specific properties. Voltage points +UT1 and UT2 are indicated on the figure. The circuit is driven from point +UT1, and the LED or solar cell is located always at point +UT2.

The LED subsequent efficiency increasing circuit is largely similar to the drive of the pulse laser diodes. However, in that case the circuit is switched on only for 1 to 5% of the time, and is interrupted during the rest of the time. In that case, the energy accumulated in condenser C is discharged to the pulse laser diode for the time of the short pulse, as it is shown on FIG. 3.

On FIG. 2, component 1 is buffer condenser C, the size of which depends on the specific capacity. Component 2 is a circuit marked with micro symbol, which is a microprocessor switch element. Component 3 is a switch element (Q), which is a semiconductor switch element. In this case, this is a FET transistor, as it is very important for it to have the minimum inner resistance. On FIG. 2, right hand point UT2 connects to both the solar controller and the optical semiconductor LED drive circuit. As regards the use of the circuit, right hand point UT2 connects to both the optical semiconductor solar cell and the optical semiconductor LED.

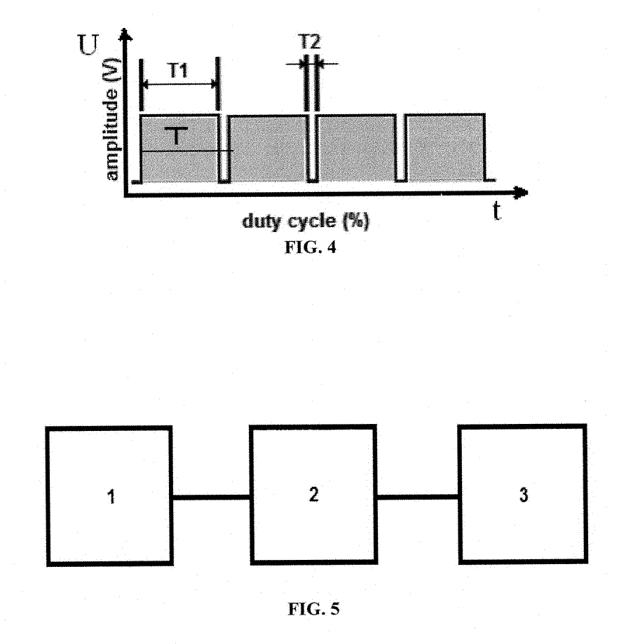

FIG. 3 is a graph illustrating a pulse series indicating a connection interval of the LED efficiency optimizing circuit provided herein. FIG. 4 is a graph illustrating a pulse series indicating a connection interval of the LED efficiency optimizing circuit provided herein.

The pulse series shown on FIG. 3 and FIG. 4 indicate the connection interval of the LED efficiency optimizing circuit covered by this invention. Repetition time T of the pulse series as well as On condition T1 and Off condition T2 are also indicated on FIG. 3 and FIG. 4.

In the case of the LED efficiency increasing circuit, the drive is performed not at 20-50 times the specific current, but with 1-2× impulse currents, and only for a period allowed on the basis of the data of the LED chip provided by the manufacturer.

In the case of the LED optimizing circuit, this procedure could not be used because the continuous LEDs are not designed for large surges of current. If a user drove the LEDs in pulse mode, the LEDs would get damaged in a very short time. The LEDs would melt due to the high current.

The LED chips operate by projecting the light excited by the chip itself to a multilayer and multispectral luminescent material. The luminescent material covers several band widths with various wave lengths. Each luminescent material has a relaxation time. This means that it emits light with different wave lengths in response to illumination, for a few milliseconds in certain cases.

Alternatively, the luminescent material may be illuminated by means of excited light only for a certain period, and not continuously. The excitation is followed by a certain break to allow us to utilize the maximum persistence energy. The switching frequency is specified to result in the maximum light output during the excitation time of the luminescent material.

FIG. 5 is a block diagram of a system for optimizing efficiency of optical semiconductor devices. FIG. 5 depicts the block diagram of the subsequent efficiency increasing circuit covered by the present disclosure for control of the control circuit of the solar cell.

FIG. 5 shows the block diagram of the optimizing circuit covered by the present disclosure for the control of the control circuit of the solar cell. In the case of the latter application, this block diagram has been created to subsequently increase the efficiency of the solar cell. On FIG. 5, box 1 contains the solar cell, box 2 contains the optimizing circuit, while box 3 contains the control circuit of the solar cell.

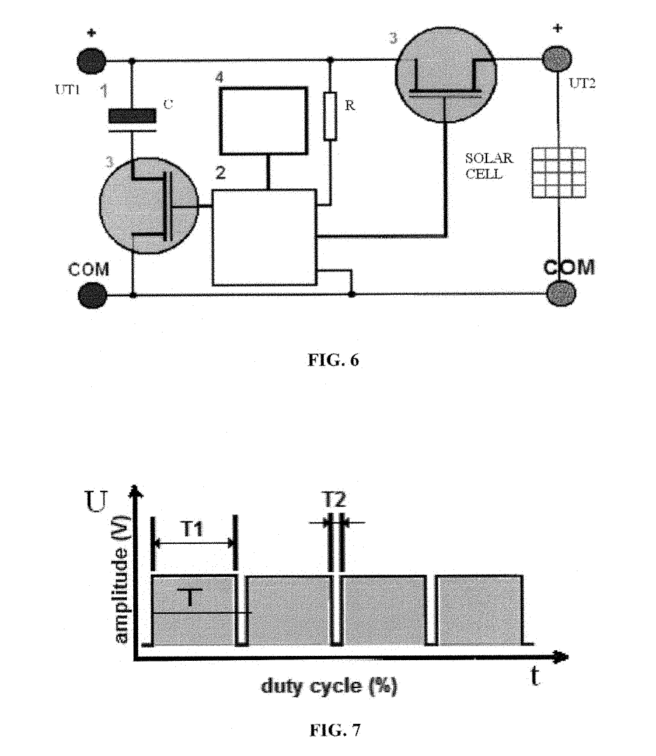

FIG. 6 is a diagram of a system for optimizing efficiency of optical semiconductor devices. FIG. 6 depicts a potential circuit diagram for the blocks indicated on FIG. 4 and intended to control solar cells.

FIG. 6 shows a potential circuit diagram for the blocks indicated on FIG. 5 and intended to control solar cells. FIG. 6 shows that the right hand input connects from the solar cell via switch element 3 to the buffer, energy storage condenser C. Component 2 is a control circuit with a processor. Component 3 is the switch element itself, which can be, in fact, any type of switch element having the specific properties (steep ramp and minimum inner resistance). The last component connects to the solar cell controller at the two blue output points.

FIG. 7 is a graph illustrating a pulse series indicating a connection interval of the LED efficiency optimizing circuit provided herein. The characteristic curve shown on FIG. 7 indicates the connection interval of the drive of the solar cell control circuit using the solution covered by the invention.

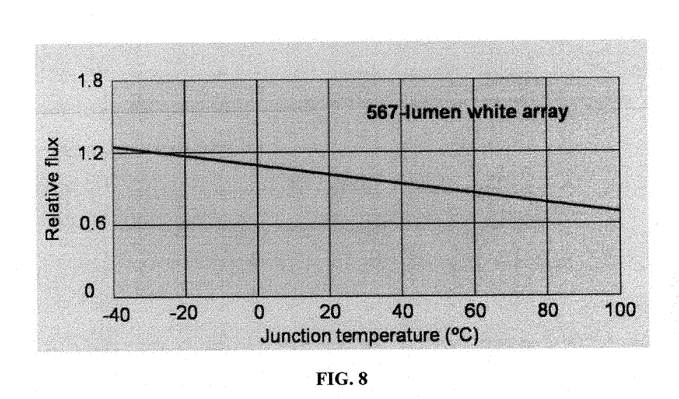

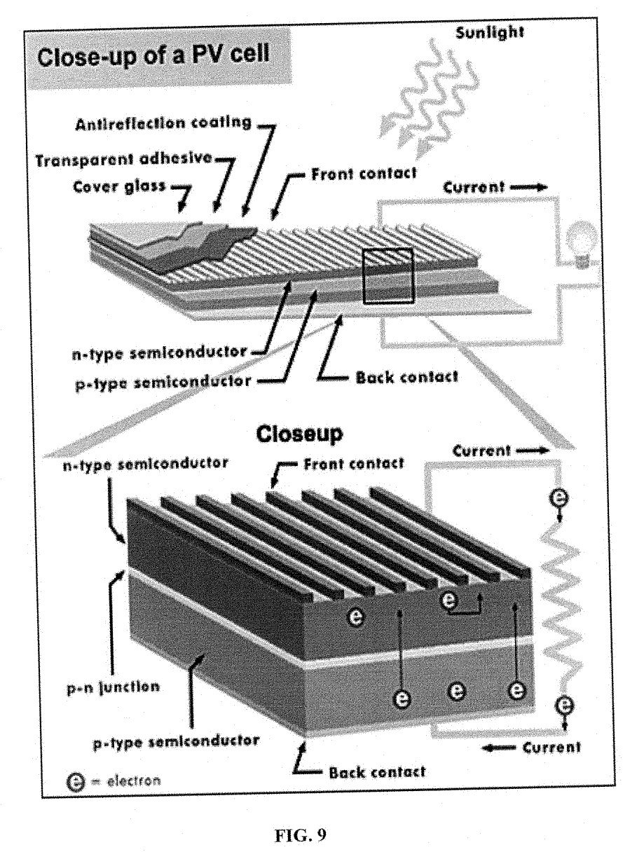

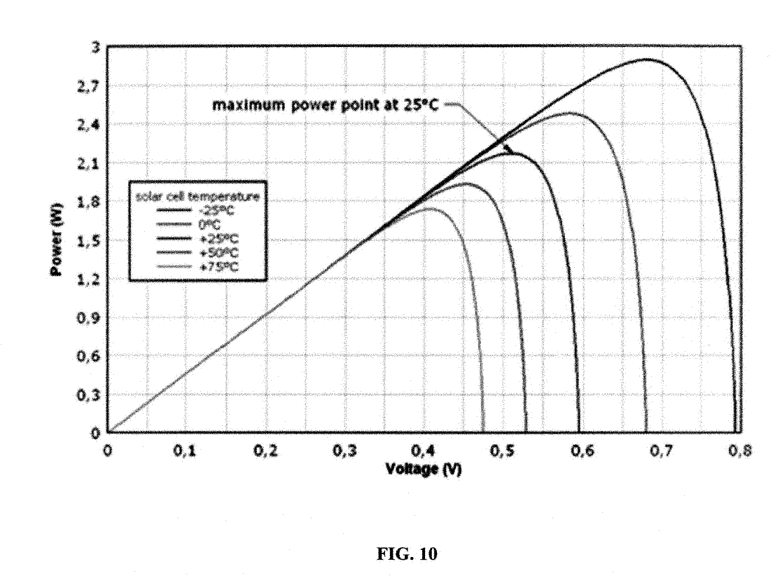

As regards the pulse series shown on FIG. 7, the horizontal line represents time t, the vertical line represents voltage U for the solar cell controller. FIG. 7 shows that the circuit is switched on for more than 95% of the given period. FIG. 7 shows that the signal from the solar cell steeply charges buffer condenser C. Then, in response to the switch element, it interrupts it in accordance with the preprogrammed function of circuit 2 provided with a processor, which depends on the Therefore the solar cell will not be continuously loaded. The short break between 1 to 5% is enough for the solar cell not to warm up during that time under the load. This short break has proven to be enough to increase the efficiency of the solar cells. The parameters set depending on the system of solar cells may increase the capacity value by up to 20-30%. Based on these two applications, it is clear that significant capacity increase can be achieved in both applications. Additional FIG. 8, FIG. 9, and FIG. 10 present comparisons between the above solutions mentioned in the state of the art.

FIG. 8 is a graph indicating characteristics of how the brightness of high capacity light-emitting (LED) optical semiconductor devices change depending on temperature according to the state of the art. FIG. 9 and FIG. 10 demonstrate the correlations between the efficiency and temperature of solar cells converting light energy by means of optical semiconductor devices according to the state of the art.

The characteristics shown on FIG. 8 illustrate how the brightness of LEDs implemented as high capacity optical semiconductor devices changes depending on the temperature. This indicates that even a change by a few C degrees may significantly affect the efficiency of the optical semiconductor device.

FIG. 9 and FIG. 10 show the correlations between the efficiency and temperature of solar cells implemented with optical semiconductor devices. The characteristics shown on these figures clearly indicate that the higher the temperature of the energy converting optical semiconductor device the lower the efficiency. This definitely confirms that any temperature reduction results in efficiency increase. This temperature reduction can be achieved by using a duty cycle from 1 to 5% to increase the efficiency.

Two notable applications of the teachings provided herein are highlighted below. First, high capacity light-emitting devices implemented with optical semiconductor devices, LEDs. Second, solar cells implemented with optical semiconductor devices.

While in the first case the capacity of the light-emitting optical semiconductor device (LED) is optimized as a load, in the second case subsequent efficiency increase may be obtained in energy conversion. In the first case related to the high capacity LED drive, inserting the circuit between the factory LED drive input and the factory LED chip can significantly increase the light-emitting capacity of the LED, while the capacity does not change, only the efficiency of light conversion increases.

The differential energy is achieved by increasing the efficiency of the electricity/light conversion of the LED. The current high capacity LED chips does not reach 50% efficiency. Using this circuit layout allows up to 75% efficiency, which is proved by laboratory measurements.

The present disclosure teaches use of an element with a microprocessor, which activates the switch element in function of the values of the heat sensor element. The benefit of the teachings herein and the circuit layout created for the application is that this capacity increase can be achieved by inserting the efficiency boosting circuit between the factory LED driver and the LED chip.

Reference items for FIG. 9 are as follows
10 sunlight
11 1-p-n transition
12 semiconductor layer type p
13 semiconductor layer type n
14 load (in the circuit)

Other reference items in various figures are as follows:
C—condenser
R—resistance
COM—common connection point, common cable
U—voltage
t—time
T—period
T1—interval
T2 —interval

What is claimed is:

1. A method to subsequently increase efficiency of optical semiconductor devices, comprising:
interrupting voltage of a light-emitting optical semiconductor device with a short duty cycle, the interrupting cycle in a range of 1%-5%; and
observing cool down of the optical semiconductor device to a greater extent than without the interruption and observing a resulting lower ambient temperature of the optical semiconductor device,
wherein the optical semiconductor devices convert light into electrical energy and experience, based on the interruption, greater increases in efficiency and lifetime than without the interruption, and wherein the optical semiconductor devices comprise at least one of comprising light-emitting optical semiconductor devices and light-absorbing optical semiconductor devices

2. The method of claim 1, wherein the optical semiconductor devices further comprise one of light-emitting devices and high capacity LEDs.

3. The method of claim 2, wherein luminescent material of light-emitting optical semiconductor devices (LEDs) is illuminated by means of excited light for a certain period, and not continuously, and the excitation is followed by a certain break to promote utilization of the maximum persistence energy, and wherein the switching frequency is specified so as to result in maximum light output during the excitation time of the luminescent material.

4. The method of claim 3, wherein with light-emitting optical semiconductor devices (LEDs) a circuit subsequently increasing efficiency of the LEDs is similar to drive of pulse laser diodes in which the circuit is switched on only for 1%-5% of the time and is interrupted during the remainder of the time and wherein the energy accumulated in condenser C is discharged to the pulse laser diode for the duration of the short pulse, in contrast to light-emitting optical semiconductor devices (LEDs) of claim 3 wherein the circuit is switched off for 1%-5% of the time and is switched on during the remainder of the time.

5. The method of claim 1, wherein the optical semiconductor devices are devices converting light energy into electric power, the devices comprising one of solar cells and solar panels.

6. The method of claim 5, wherein the solar cell connects to a buffer energy storage condenser C via a switch element, and an optimising circuit comprises a control circuit with a processor activating the switch element on the basis of a signal from a heat sensor element and a voltage meter, the switch element comprising a switch element exhibiting the specific properties.

7. The method of claim 5, wherein a signal from the solar cell steeply charges buffer condenser C followed by the switch element controlled by a unit with a processor interrupting the signal in function of the preset value of the heat sensor element, thereby not continuously loading the solar cell and resulting in a short break between 1% and 5% being sufficient to avoid heating up of the solar cell under the load.

8. The method of claim 7, wherein with solar cells, the short break and a capacity value of buffer C are sufficient to significantly increase the efficiency of the solar cells such that the capacity value can be increased by up to 30% depending on the parameters set in accordance with the system of the solar cells.

9. The method of claim 8, wherein condenser C is a buffer condenser the size of which depends on the specific capacity.

10. The method of claim 8, wherein a transistor comprising at least an FET transistor is used as a switch element, wherein the switch element is required to have the lowest inner resistance.

11. The method of claim 6, wherein in an actual advantageous application an element with a microprocessor is used, which activates the switch element in function of the preset values of the heat sensor element.
